(19) United States
(12) Patent Application Publication
(10) Pub. No.: US 2010/0170371 A1
(43) Pub. Date: Jul. 8, 2010

(54) PRECISION GUIDANCE DEVICE IN A MACHINE FOR MACHINING CYLINDRICAL COMPONENTS

(76) Inventors: Pierre-Louis Piguet, Les Geneveys-sur-Coffrane (CH); Pierre Pahud, Porrentruy (CH)

Correspondence Address: Clifford W. Browning;Krieg DeVault LLP, One Indiana Square, Suite 2800, Indianapolis, IN, 46204-2079, US

(21) Appl. No.: 12/733,353

(22) PCT Filed: Aug. 28, 2008
(86) PCT No.: PCT/IB2008/053476

§ 371 Date: Feb. 24, 2010

(30) Foreign Application Priority Data
Aug. 31, 2007 (EP) 07115418.1

(51) Int. Cl. B23B 3/00

(52) U.S. Cl. 82/121

(57) ABSTRACT

According to the invention, the pin (6) is rotated by the motor (5) via the belt (10) and the pulley (11) that is precision-held on the fixed bushing (13). It comprises a pin arm (16) whose solid rear portion (20) rotates in the bushing (13) and is coupled by screws (18), and the centring part (19) at the inner area of the pseudo universal-joint disk (17) whose outer area is coupled to the pulley (11). A second pseudo universal-joint connection is provided between the rear portion (20) of the pin arm (16) and the front portion thereof (21), which is connected to the clamp-holding bushing (7) in which the clamping collet (8) is mounted.

### TECHNICAL FIELD

Machining of certain cylindrical tools made of hard materials, such as more or less long small diameter drills, must fulfil increasingly high demands for precision.

### BACKGROUND OF THE INVENTION

In conventional machines, one generally finds a component receiving device consisting of a fixed vee supplemented by a tightening finger. These devices remove four degrees of freedom from the bar to be machined: two rotations and two translations. In order for guidance to be precise and complete, it therefore remains for the drive device to remove the remaining two degrees of freedom: the axial displacement and the rotation around the axis of the component, with the requirement of the latter not being cancelled but digitally controlled in order to allow interpolation with the other movements of the machine.

Document U.S. Pat. No. 4,971,339 describes the arrangement of a guidance device which allows to avoid the creation of parasitic effects by the driving means on the component receiving device, but this known arrangement does not guarantee a strict control between the drive motor and the lightening clamp.

### SUMMARY OF THE INVENTION

The aim of the present invention is to create a perfected workhead capable of being mounted on the stand of a machining machine in which the component receiving device holds the components with the necessary precision, this workhead being designed such as to perfectly control the two remaining degrees of freedom without resulting in parasitic effects liable to affect the precision of the machining.

To this end, the aim of the present invention is a precision guidance device in a machine for machining cylindrical components, comprising a workhead mounted on a stand and comprising a floating spindle connected at one end to a motor driving the latter in rotation and at the other end to a tightening clamp capable of completely gripping said components, the latter being guided along a fixed axis in a guidance system, characterised in that said floating spindle is arranged such that said components are on the one hand rigidly coupled in rotation with the motor and on the other hand are free to float radially in relation to said guidance system.

According to an embodiment said tightening clamp is arranged inside a composite spindle shaft forming part of the floating spindle.

The composite spindle shaft may form part of a spindle assembly comprising two elastically deformable parts, each having a linking element, with these elements being fixed rigidly to one another.

One of said elastically deformable parts of the spindle assembly may comprise an input element coupled to a pulley connected to the motor and carried along an axis which is strictly fixed in relation to the stand and the other elastically deformable part of the spindle assembly may comprise a front output element to a which a clamp holder socket supporting said tightening clamp is fixed.

The drive pulley may be carried by a system of ball bearings on a fixed socket which is secured to the stand and in which the spindle assembly freely rotates.

Each of said deformable elastic parts of the spindle assembly may be formed of an open-worked annular part such as to present a symmetry axis capable of limited-range angular displacement.

Said elastically deformable parts of the spindle assembly may be fixed to one another coaxially by said linking elements such that radial displacements between the tightening clamp and the drive pulley do not result in any parasitic effort, whilst the drive torque is transmitted without any deformation and without any play.

Each of said elastically deformable parts of the spindle assembly may comprise three distinct areas delimited by two pairs of shaped openings extending in a circular arc around the axis of the shaft and only leaving between them in each pair two cruciform elements, respectively two thin webs located in the same diametrical plane, with each pair of cruciform elements, respectively webs, connecting a first area to a second or the second to the third at two diametrically opposite locations in order to allow said radial displacements between said input and output elements of the spindle assembly.

One of said elastically deformable parts of the spindle assembly may have the shape of a disc, the external area of which forms the input element rigidly coupled to the drive pulley and the other elastically deformable part of the spindle assembly may have the form of an elongated spindle shaft, said areas of which are spaced apart along said shaft and whose end opposite the linking element forms the output element interdependent with the clamp holder socket.

### BRIEF DESCRIPTION OF THE DRAWINGS

An embodiment of the invention is described below as a mere example, referring to the appended drawing in which:

FIG. 1 is a perspective view of a workhead with a floating spindle forming part of the guidance device,

FIG. 2 is a vertical cross-sectional view of the workhead in FIG. 1, along the axis of the floating spindle,

FIGS. 3A and 3B are perspective views of an open-worked part forming part of the spindle and

FIG. 4 is a perspective view of the spindle shaft with open-worked forward section.

### DETAILED DESCRIPTION OF EMBODIMENTS OF THE INVENTION

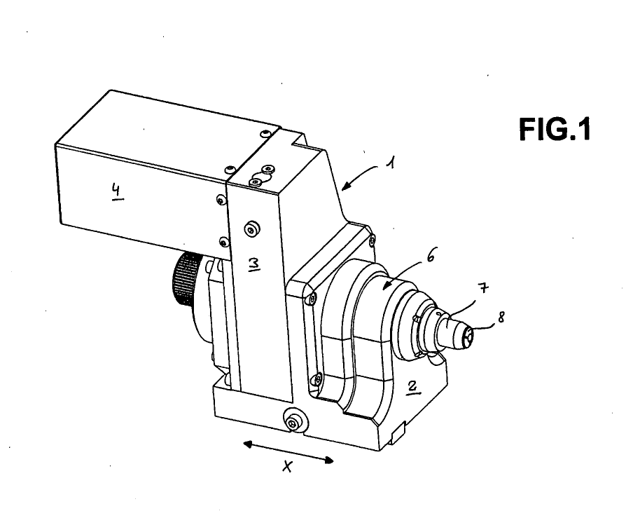

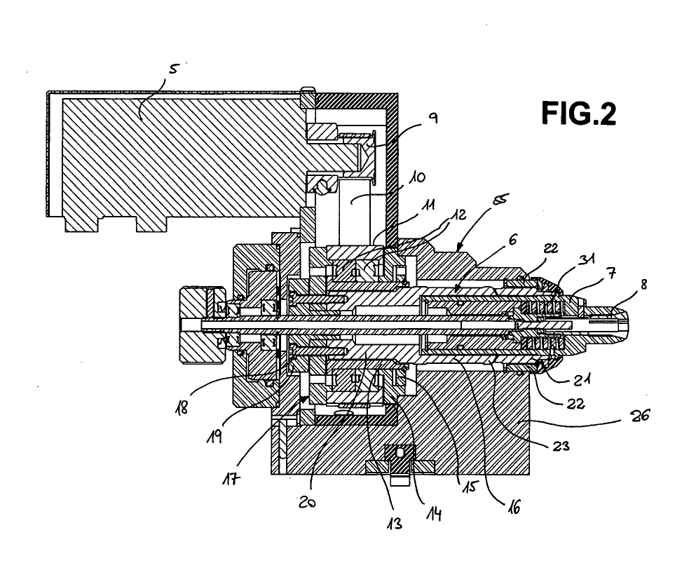

FIG. 1 shows a workhead 1 with a floating spindle comprising a stand 2 designed for installation on a base of the machine, while being guided with precision along an axis X in relation to this base. A motor support generally denoted by the number 3 is rigidly fixed to the stand 2, containing a digitally-controlled drive motor (5) (FIG. 2) in an envelope 4.

This drive motor 5 is designed to rotate cylindrical elongated components, such as drills for example, made of a very hard material, which must be dressed or rectified by grinding wheels installed and guided on the base of the machine. In order to achieve the necessary precision, it is essential that the components to be machined be held in a component receiving device (not illustrated here) which guides the components by determining four degrees of freedom, i.e. two rotations and two translations in space. The components thereby having a precisely determined position and orientation of their axis, by means of the component receiving device, the drive motor 5 must control rotation around the component axis, whilst the axial displacement of the workhead 1 determines the last degree of freedom.

In order to ensure that these two degrees of freedom are controlled without parasitic efforts resulting from misalignments between the guidance device and the drive mechanism, the workhead 1 is equipped with a floating spindle generally denoted by 6 (FIG. 2) and receiving said components to be machined.

The floating spindle 6 appears in FIG. 1 in which the end of a clamp holder socket 7 containing and controlling a clamp 8 for locking the component to be machined can be seen.

FIG. 2 shows the construction of the drive mechanism of the socket 7. The motor shaft 5 bears a drive pulley 9 which drives a spindle pulley 11 by means of a synchronous belt 10. In order to avoid transmitting the tractive efforts of the synchronous belt to the spindle shaft 6, the pulley 11 is mounted on two ball bearings 12 the internal rings of which are installed on a stand socket 13 which is rigidly secured to the stand 2 by means of a fixed ring 14 and a spacer 15.

With this installation, the radial efforts are not transmitted to the shaft; only the drive torque is transmitted.

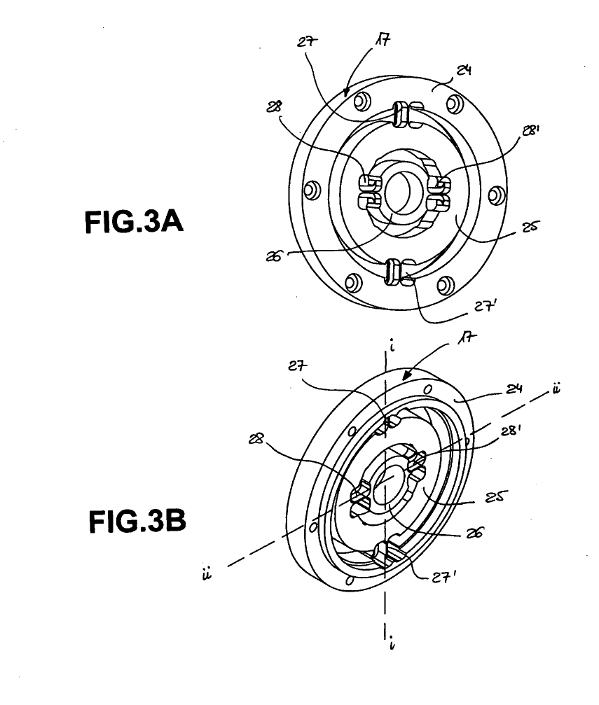

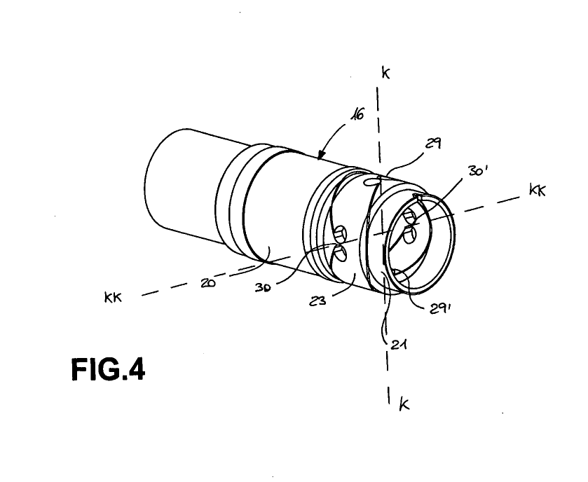

In order to ensure transmission of the movements and efforts under the conditions indicated above, the spindle 6 comprises a spindle shaft 16 connecting the spindle pulley 11 to the clamp holder socket 7. The pulley 11 is secured to an external circular section of a pseudo-universal joint disc 17 having a fixed central section, by screws 18 and a centring component 19, against the rear face of the solid section 20 of the spindle shaft 16. The solid section 20 of the spindle shaft 16 rotates freely in the stand socket 13, whilst its front end 21, secured to the clamp holder socket 7, is guided in a fixed socket 22. Between the two rear 20 and front 21 solid sections of the spindle shaft 16, a deformable section 23 is arranged, which is better represented in FIG. 4, also acting as a pseudo-universal joint, like the intermediate area of the component 17 (refer to FIGS. 3 and 4).

Although differently configured, the disc 17 and the deformable section 23 of the spindle shaft 16 are elements that play similar roles in functional terms.

In FIG. 3, the pseudo-universal joint disc 17 comprises an external peripheral area 24 provided with openings for screw fixing to the pulley 11, and intermediate area 25 and an annular central area 26 with openings (not illustrated) for the screws 18. Extending between these areas are two pairs of circular arc-shaped openings which only leave between their ends in each pair respectively two cruciform elements 27, 27′ and 28, 28′ arranged radially according to planes comprising the axis of the component 17 and perpendicular to one another. By means of these cruciform elements 27 and 28, the areas 24 and 25 and areas 25 and 26 are connected to each other respectively such that limited-range angular displacements around the axes i and ii are possible between the external area 24 and the central area 26.

According to FIG. 4, finally, which represents the tubular section of the spindle shaft 16, one can distinguish a rear solid area 20 separated from a front solid area 21 by the deformable section 23, the latter being limited by two pairs of narrow slot-shaped openings which surround the axis of the shaft, each over practically half the revolution of the shaft and which only leave between their ends the thin webs 29, 29′ and 30, 30′ connecting each area 20 or 21 to the intermediate area 23. Here also, the planes common to the webs 29 and the webs 30 are perpendicular to one another. Small angular displacements between areas according to the axes k and kk are almost freely possible.

The clamp 8 and therefore the component to be machined which is held in the spindle 6 by a conventional tightening device 31, is connected to the drive pulley 9 by means of two pseudo-universal joints, the cruciform elements 27, 28 and the webs 29 and 30, which allow misalignments of the component both parallel and angular in relation to the drive pulley 9 and therefore in relation to the stand 2. In the axial direction, on the other hand, the component is held rigidly, since the cruciform elements 27, 28 and the webs 29, 30 cannot be deformed in this direction. Likewise, in rotation, the link between the component secured in the clamp 8 and the servomotor 5 is rigid, which allows angular control and its interpolation with the other digital axes of the machine.

Consequently, the clamp 8 and therefore the component which is retained by its tightening system 31, is connected to the drive pulley by means of two pseudo-universal joints, elements 27, 28 and 29, 30, which allow misalignments of the component, both parallel and angular in relation to the drive pulley 11 and therefore in relation to the base 26. Axially, on the other hand, the component is held rigidly, since the elements 27, 28 and 29, 30 cannot be deformed in this direction. Likewise, in rotation, the link between the component and the servomotor is rigid, which allows angular control and its interpolation with the other digital axes of the machine.

Consequently, the device produced guarantees absence of play and absence of wear in comparison to any device traditionally equipped with universal joints.

1. Precision guidance device in a machine for machining cylindrical components, comprising a workhead mounted on a stand and comprising a floating spindle connected at a first end to a motor driving said spindle in rotation and at a second end to a tightening clamp capable of completely gripping said components, said components being guided along a fixed axis in a guidance system, wherein said floating spindle is arranged such that said components are on the one hand rigidly coupled in rotation with the motor and on the other hand are free to float radially in relation to said guidance system.

2. Device according to claim 1, that wherein said tightening clamp is arranged inside a composite spindle shaft forming part of the floating spindle.

3. Device according to claim 2, wherein the composite spindle shaft forms part of a spindle assembly comprising two elastically deformable parts, each having a linking element, with these elements being fixed rigidly to one another.

4. Device according to claim 3, wherein one of said elastically deformable parts of the spindle assembly comprises an input element coupled to a pulley connected to the motor and carried along an axis which is strictly fixed in relation to the stand and wherein the other elastically deformable part of the spindle assembly comprises a front output element to a which a clamp holder socket supporting said tightening clamp is fixed.

5. Device according to claim 4, wherein the drive pulley is carried by a system of ball bearings on a fixed socket which is secured to the stand and in which the spindle assembly freely rotates.

6. Device according to claim 4, wherein each of said deformable elastic parts of the spindle assembly is formed of an open-worked annular part such as to present a symmetry axis capable of limited-range angular displacement.

7. Device according to claim 6, wherein said elastically deformable parts of the spindle assembly are fixed to one another coaxially by said linking elements such that radial displacements between the tightening clamp and the drive pulley do not result in any parasitic effort, whilst a drive torque is transmitted without any deformation and without any play.

8. Device according to claim 7, wherein each of said elastically deformable parts of the spindle assembly comprises three distinct areas delimited by two pairs of shaped openings extending in a circular arc around an axis of the shaft and only leaving between them in each pair two cruciform elements, respectively two thin webs located in a same diametrical plane, with each pair of cruciform elements, respectively webs, connecting a first area to a second or the second to the third at two diametrically opposite locations in order to allow said radial displacements between said input and output elements of the spindle assembly.

9. Device according to claim 8, wherein one of said elastically deformable parts of the spindle assembly is in the shape of a disc, with an external area forming an input element rigidly coupled to the drive pulley and wherein the other elastically deformable part of the spindle assembly has the form of an elongated spindle shaft, said areas of which are spaced apart along said shaft and whose end opposite the linking element forms the output element interdependent with the clamp holder socket.
